(19) United States
(12) Patent Application Publication
(10) Pub. No.: US 2024/0349648 A1
(43) Pub. Date: Oct. 24, 2024

(54) PORTABLE TELESCOPIC PUSH-PULL VIBRATING-SHAKING TYPE CAMELLIA OLEIFERA FRUIT PICKING AND BEATING MACHINE

(71) Applicant: Anhui Agricultural University, Hefei City (CN)

(72) Inventors: Chengmao Cao, Hefei City (CN); Yan SUN, Hefei City (CN); Manyu WU, Hefei City (CN); Xu LI, Hefei City (CN); Lin CHAI, Hefei City (CN); Zhongbin LIU, Hefei City (CN); Wuyang DING, Hefei City (CN); Liang SUN, Hefei City (CN)

(21) Appl. No.: 18/588,302

(22) Filed: Feb. 27, 2024

(30) Foreign Application Priority Data
Apr. 23, 2023 (CN) 202310438187.2

(51) Int. Cl. A01D 46/26

(52) U.S. Cl. CPC A01D 46/264; A01D 2046/266

(57) ABSTRACT

Disclosed is a portable telescopic push-pull vibrating-shaking type Camellia oleifera fruit picking and beating machine. The machine includes a picking and beating head, a gear shifting mechanism, a power transmission and picking and beating rod, a direct current motor, a control system, a handheld grip, and a lithium battery. A battery supplies power to enable the direct current motor to rotate, the direct current motor drives a worm and worm wheel mechanism in the gear shifting mechanism to rotate through a power transmission rod, the worm and worm wheel mechanism drives the picking and beating head to achieve reciprocating push-pull motion, such that the picking and beating rod can pull a branch to generate push-pull and vibration to pick Camellia oleifera fruit down. The picking and beating head is provided with a force sensor capable of monitoring picking and beating strength at any time.

### CROSS-REFERENCE TO RELATED APPLICATION

This patent application claims the benefit and priority of Chinese Patent Application No. 2023104381872, filed with the China National Intellectual Property Administration on Apr. 23, 2023, the disclosure of which is incorporated by reference herein in its entirety as part of the present application.

### TECHNICAL FIELD

The present disclosure relates to the technical field of agricultural machinery, and in particular to a portable telescopic push-pull vibrating-shaking type Camellia oleifera fruit picking and beating machine.

### BACKGROUND

Camellia oleifera is a unique woody oil crop in China, and is also one of the four largest woody edible oil materials in the world, which is as famous as oil palm, olive and coconut. There are abundant Camellia oleifera resources in China. The oil extracted from Camellia oleifera seeds is called Camellia oleifera seed oil, which is nutritious, rich in unsaturated fatty acids such as oleic acid and linoleic acid. Regular consumption of such green natural Camellia oleifera oil with high nutritional value can effectively reduce blood pressure and blood lipid, and even play a good role in preventing cardiovascular diseases such as sclerosis. The Camellia oleifera oil is called “Oriental Olive Oil”. In recent years, with increasing attention of people to health and other issues, Camellia oleifera is known by more and more people, so Camellia oleifera oil is more and more favored by people. In addition, the Camellia oleifera seed oil is also rich in vitamins A, E, D and K, β-carotene, squalene and other physiologically active substances.

However, the traditional methods for picking Camellia oleifera fruits are basically manual picking, that is, when picking Camellia oleifera fruits, people need to climb up the tree to pick Camellia oleifera fruits one by one. When the people climb up the tree for Camellia oleifera fruit picking, it is neither safe nor convenient to use force at high altitude, and the Camellia oleifera fruits are difficult to pick. Moreover, this method is high in labor strength, requires amount of labor, and is inefficient. Although a method for knocking Camellia oleifera fruits off from the tree by using a stick is also used and can avoid safety accidents when people climb up the tree, this method is easy to damage branches and buds, and has the problems of affecting the growth of the tree and reducing the yield of Camellia oleifera in the coming year.

In recent years, although there have been some design achievements of vibrating Camellia oleifera fruit picking and beating machines, most of which are relatively large machines, which are suitable for picking Camellia oleifera fruits in some plain regions, but cannot be used for picking Camellia oleifera fruits growing on high mountains and steep slopes with a slope of 25° and more.

Therefore, it is necessary to provide a portable telescopic push-pull vibrating-shaking type Camellia oleifera fruit picking and beating machine, which is portable in steep slopes in mountainous areas, convenient to operate, high in safety, free of damaging branches and buds, and worth of popularization.

### SUMMARY

In order to overcome the problems in the background, a portable telescopic push-pull and vibrating type Camellia oleifera fruit picking and beating machine is provided, through which people can directly pick Camellia oleifera fruits scattered on the tree when standing on the ground. The machine is simple in structure, convenient to operate, high in safety, convenient to carry in mountainous areas, free of damaging branches of Camellia oleifera, free of affecting the yield of Camellia oleifera fruits in the coming year, high in picking efficiency and low in labor intensity.

To achieve the objectives above, the technical solution adopted by the present disclosure is as follows:

A portable telescopic push-pull vibrating-shaking type Camellia oleifera fruit picking and beating machine mainly includes a picking and beating head, a gear shifting mechanism, a power transmission and picking and beating rod, a direct current (DC) motor, a control system, a handheld grip, and a lithium battery. The picking and beating rod includes a long hook, the long hook is provided with a silicone case at an inner upper end and a displacement sensor at an inner lower end, and a tail portion of the long hook is provided with a force sensor and a telescopic rod fixing hole for connecting and fixing the gear shifting mechanism. The gear shifting mechanism includes a telescopic rod for connecting and fixing the picking and beating head, the telescopic rod penetrates through a linear sliding bearing, and a worm and worm wheel mechanism is fixedly connected to a tail portion of the telescopic rod. A rear portion of the worm and worm wheel mechanism is provided with a steel tube track and a power transmission and picking and beating rod fixing groove. The power transmission and picking and beating rod includes a power transmission rod, the power transmission rod is externally wrapped with a plastic housing, and the power transmission and picking and beating rod is connected to the gear shifting mechanism and the DC motor. A housing surface of the DC motor is provided with DC motor thermal vias. The control system includes a power switch, a start switch is arranged at a side portion of the power switch, and the power switch and the start switch are installed on the handheld grip. The power switch and the start switch are electrically connected to a circuit board by means of a power switch wire and a start switch wire, respectively. The circuit board is electrically connected to the lithium battery by means of a battery wire and is electrically connected to the DC motor by means of a DC motor wire. A STM-32 single chip microcomputer is arranged on the circuit board, one end of the STM-32 single chip microcomputer is electrically connected to the circuit board, and the other end of the STM-32 single chip microcomputer is electrically connected to the DC motor by means of a control wire.

Preferably, the picking and beating head detects picking and beating strength at any time by the force sensor, can achieve an adaptive control through a fuzzy control system, and is fixedly connected with the telescopic rod of the gear shifting mechanism through a telescopic rod fixing hole. The long hook of the picking and beating head can hook a branch easily, and a special silicone material is free of hurting the bark. The force sensor can detect the picking and beating strength at any time, and the adaptive control is achieved through a fuzzy control system to make the picking and beating strength in a stable range, and thus the Camellia oleifera fruits are ensured to drop, but the buds do not.

Preferably, the gear shifting mechanism further includes a linear sliding bearing fixing groove for fixedly mounting the linear sliding bearing, a rear portion of the linear sliding bearing fixing groove is provided with a steel tube track, and a rear portion of the steel tube track is provided with a rotating rod fixing groove and an angular contact ball bearing fixing groove.

Preferably, the worm and worm wheel mechanism includes a slider fixedly connected to the telescopic rod, and the slider is provided with a pulley connected to the steel tube track. A rear portion of the slider is provided with a double-crank connecting rod, and the slider is indirectly connected to rotating arms through the double-crank connecting rod, and is connected to a worm wheel through the rotating arms and the double-crank connecting rod. The rotating arms are connected to a worm arranged on the worm wheel through the worm wheel, and both sides of each of the worm and the worm wheel on the rotating arm are provided with the angular contact ball bearings.

Preferably, the power transmission and picking and beating rod is connected to the worm in the gear shifting mechanism and the DC motor through particular hexagonal keyhole interfaces. The power transmission and picking and beating rod may also be lengthened, and is difficult to drop through the particular hexagonal keyhole interface, so as to cope with trees with different heights. A rotation of the DC motor is transmitted to the worm in the gear shifting mechanism through the power transmission rod in the power transmission and picking and beating rod, a rotation of the worm drives the worm wheel to rotate, a rotation of the worm wheel drives the symmetrical rotating arms on both sides to make 360° motion, and the other ends of the rotating arms are connected to the slider through the double-crank connecting rod to drive the slider to make back-and-forth push-pull motion. Each of an upper portion and a lower portion of the up-down symmetrical slider is provided with two pulleys, and the slider drives the pulleys to move back and forth on the steel tube track. The back-and-forth motion of the pulleys on the steel tube track can reduce friction and increase kinetic energy. The other end of the slider is connected to the telescopic rod and drives the telescopic rod to extend and retract, thus playing a role in fixing and reducing the friction.

The worm and worm wheel mechanism adopted is applied to the gear shifting mechanism due to its smooth transmission, less impact, vibration and noise, which can smoothly transmit the rotation of the DC motor to the telescopic rod. The slider, the pulley and steel tube track are also provided in the middle to reduce the friction and the loss of kinetic energy, which makes the vibration and shaking more powerful. The telescopic rod is also equipped with a linear sliding bearing. Due to the fact that a bearing ball is in point contact with a bearing sleeve, a steel ball rolls with a minimum friction resistance, so the linear bearing is small in friction, relatively stable and incapable of changing with bearing speed, and thus stable linear motion with high sensitivity and high precision can be obtained. The use of the linear bearing can stabilize the telescopic rod and reduce the friction, so as to transfer the kinetic energy to the picking and beating head to the maximum extent.

Preferably, the DC motor is a single-stage planetary outer-rotor self-cooling brushless motor with the power of 400 W, and rotational speed of the motor is from 6,000 r/min to 12,000. The motor can operate for a long time, and is provided with DC motor thermal vias for increasing heat dissipation, and thus the life span of the motor is as long as 20 thousand hours.

Preferably, the STM-32 single chip microcomputer is used to control the rotational speed of the DC motor by receiving a signal from the force sensor and reasoning using a fuzzy reasoning rule algorithm, so as to achieve slow start and automatic augmentation of the power. A current of the DC motor is fed back to the STM-32 single chip microcomputer, and a power-off protection is achieved by a fuzzy control of the control system. During operation, the handheld grip is held tightly, the power switch is turned on first, which is pressed for three seconds to prevent accidental touch, and then the start switch is turned on to start operation. According to the picking and beating strength of the picking and beating head in initial contact with a branch, the STM-32 single chip microcomputer controls the rotational speed of the DC motor by receiving the signal from the force sensor and reasoning using fuzzy rules, so as to achieve slow start and automatic augmentation of the power. According to the fuzzy reasoning rule algorithm, the motor outputs different torques, thus effectively protecting the branches and tree buds during the automatic picking and beating process, making the buds damaged and dropping less. Moreover, the current of the DC motor can be fed back to the STM-32 single chip microcomputer. When the current is excessive, the control system achieves a power-off protection through the fuzzy control, thus preventing the DC motor from stalling and burning out.

Preferably, a tail portion of the control system is electrically connected to the lithium battery by means of a battery wire, and a tail portion of the lithium battery is provided with a battery back cover connected to the control system. The lithium battery is a rechargeable high-performance special lithium battery independently developed, which can operate for 3-4 hours when fully charged, and is convenient to replace.

The present disclosure has the beneficial effects that:

The portable telescopic push-pull vibrating-shaking type Camellia oleifera fruit picking and beating machine provided by the present disclosure has the characteristics of simple and compact structure, safe and reliable performance, convenient and easy-to-understand operation, portability, high efficiency and the like, and can avoid the danger of manually climbing tree for picking.

A branch vibrating-shaking picking mode is adopted in the present disclosure, as a vibration position is closer to the Camellia oleifera fruit, and the vibration transmission loss can be reduced. Compared with a trunk vibration mode, larger vibration power is not required, energy can be saved, and the picking efficiency can be improved.

The length of the power transmission and picking and beating rod adopted in the present disclosure can be freely adjusted with the change of the height of the tree, and thus the power transmission and picking and beating rod is suitable for picking Camellia oleifera fruits at different heights.

The housing is made of plastic, which is light in weight and convenient to carry, and capable of reducing the weight born by the branch, thus preventing the branch from being damaged.

The picking and beating head is internally provided with silicone, which is free of hurting the bark and is difficult to drop.

In the present disclosure, the fuzzy control system is used to regulate the picking and beating strength, the force sensor is used to measure the picking and beating strength, and the displacement sensor is used to measure the thickness of the branch and to transmit a signal to the SIM-32 single chip microcomputer. The rotational speed of the DC motor is controlled and regulated using the fuzzy control reasoning, so as to achieve automatic regulation of the picking and beating strength. For the branches with different thicknesses, a reasonable picking and beating strength can be provided. Therefore, the Camellia oleifera fruit can be picked without damaging the branches, the dropping of the buds can be reduced, and the yield in the coming year will not be influenced.

The machine is further provided with an emergency stop device to prevent the DC motor from stalling and burning out.

The present disclosure is suitable for high mountains and steep slopes with a slope of 25° and more, with a total weight of less than 5 Kg and intelligent adaptive strength control. The battery life of the special lithium battery is 3-4 h, the power of the special brushless motor is 400 W, the picking efficiency is more than 10 plants/h, the net picking rate is more than 97%, and the bud damage rate is less than 5%.

### BRIEF DESCRIPTION OF THE DRAWINGS

FIG. 1 is a schematic diagram of an overall structure of a portable telescopic push-pull vibrating-shaking type Camellia oleifera fruit picking and beating machine according to the present disclosure;

FIG. 2 is a structural schematic diagram of a picking and beating head of a portable telescopic push-pull vibrating-shaking type Camellia oleifera fruit picking and beating machine according to the present disclosure;

FIG. 3 is a schematic diagram of an upper internal sectional structure of a gear shifting mechanism of a portable telescopic push-pull vibrating-shaking type Camellia oleifera fruit picking and beating machine according to the present disclosure;

FIG. 4 is a schematic diagram of a lower internal sectional structure of a gear shifting mechanism of a portable telescopic push-pull vibrating-shaking type Camellia oleifera fruit picking and beating machine according to the present disclosure;

FIG. 5 is a structural schematic diagram of a worm and worm wheel mechanism of a portable telescopic push-pull vibrating-shaking type Camellia oleifera fruit picking and beating machine according to the present disclosure;

FIG. 6 is a schematic diagram of an internal sectional structure of a power transmission and picking and beating rod of a portable telescopic push-pull vibrating-shaking type Camellia oleifera fruit picking and beating machine according to the present disclosure;

FIG. 7 is a schematic diagram of an external structure of a control system of a portable telescopic push-pull vibrating-shaking type Camellia oleifera fruit picking and beating machine according to the present disclosure;

FIG. 8 is a schematic diagram of an internal sectional structure of a control system of a portable telescopic push-pull vibrating-shaking type Camellia oleifera fruit picking and beating machine according to the present disclosure.

In the drawings: 1—picking and beating head; 2—gear shifting mechanism; 3—power transmission and picking and beating rod; 4—DC motor; 5—control system; 6—handheld grip; 7—lithium battery; 8—DC motor thermal vias; 9—battery back cover; 11—long hook; 12—silicon case; 13—force sensor; 14—displacement sensor; 15—telescopic rod fixing hole; 21—linear sliding bearing fixing groove; 22—steel tube track; 23—worm wheel fixing groove; 24—angular contact ball bearing fixing groove; 25—telescopic rod; 26—linear sliding bearing; 27—worm and worm wheel mechanism; 28—steel tube track; 29—power transmission and picking and beating rod fixing groove; 271—angular contact ball bearing; 272—worm; 273—worm wheel; 274—rotating arm; 275—double-crank connecting rod; 276—pulley; 277—slider; 31—power transmission rod; 32—plastic housing; 51—power switch; 52—start switch; 53—DC motor wire; 54—control wire; 55—circuit board; 56—power switch wire; 57—start switch wire; 58—STM-32 single chip microcomputer; 59—lithium battery wire.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

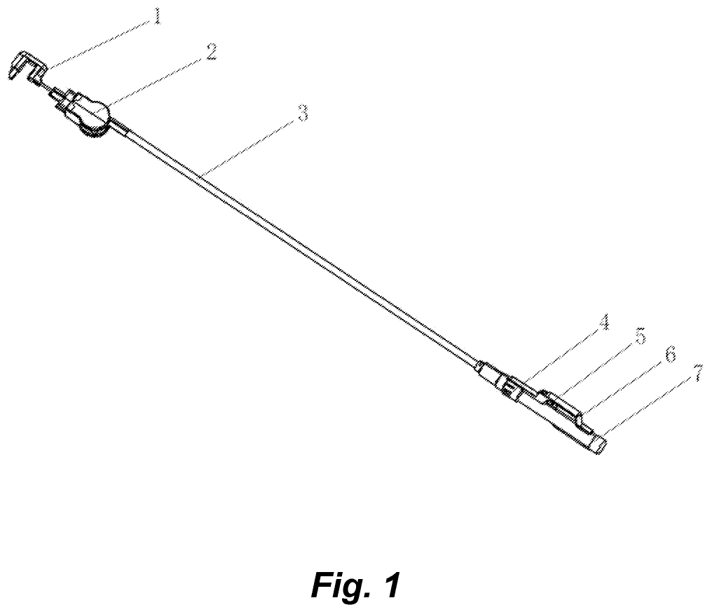

As shown in FIG. 1, a portable telescopic push-pull vibrating-shaking type Camellia oleifera fruit picking and beating machine mainly includes a picking and beating head 1, a gear shifting mechanism 2, a power transmission and picking and beating rod 3, a direct current motor 4, a control system 5, a handheld grip 6, and a lithium battery 7.

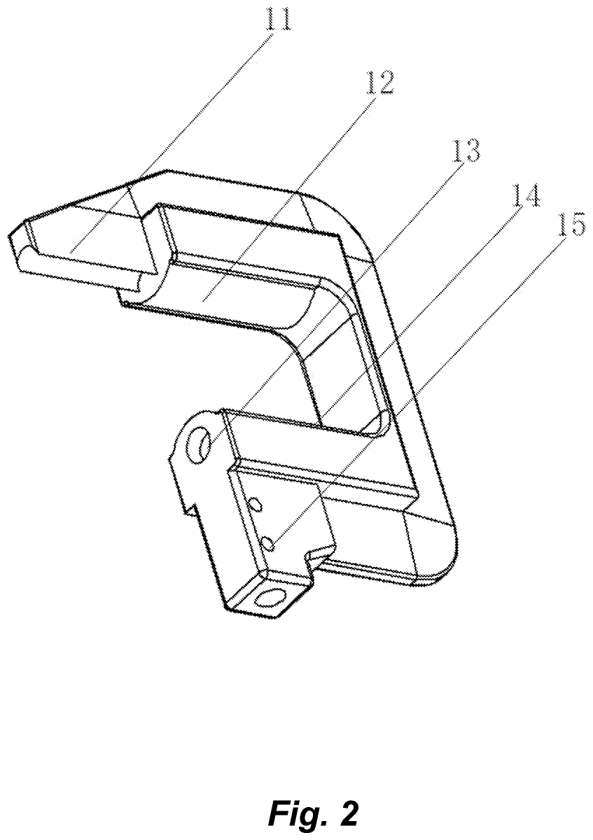

As shown in FIG. 2, in the portable telescopic push-pull vibrating-shaking type Camellia oleifera fruit picking and beating machine, the picking and beating rod 1 includes a long hook 11, the long hook 11 is provided with a silicone case 12 at an inner upper end and a displacement sensor 14 at an inner lower end, and a tail portion of the long hook 11 is provided with a force sensor 13 and a telescopic rod fixing hole 15 for connecting and fixing the gear shifting mechanism 2.

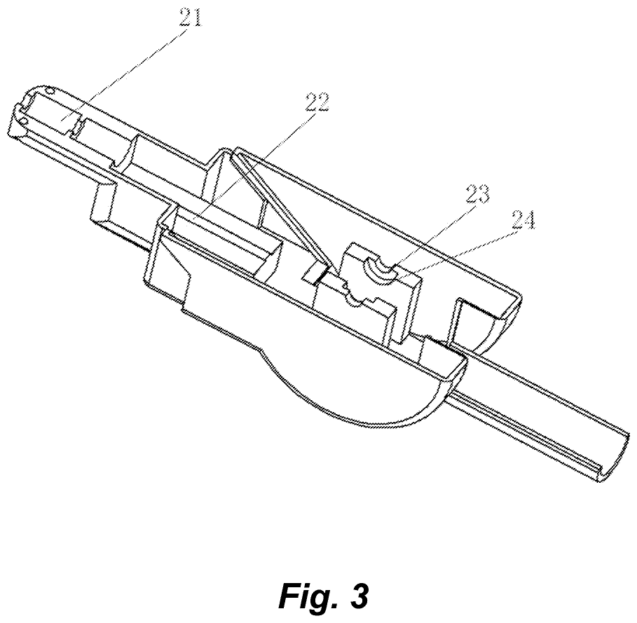

As shown in FIG. 3, in the portable telescopic push-pull vibrating-shaking type Camellia oleifera fruit picking and beating machine, the picking and beating head 1 detects picking and beating strength at any time by the force sensor 13, can achieve an adaptive control through a fuzzy control system, and is fixedly connected with the telescopic rod 25 of the gear shifting mechanism 2 through a telescopic rod fixing hole 15. The gear shifting mechanism 2 further includes a linear sliding bearing fixing groove 21 for fixedly mounting a linear sliding bearing 26, a rear portion of the linear sliding bearing fixing groove 21 is provided with a steel tube track 22, and a rear portion of the steel tube track 22 is provided with a rotating rod fixing groove 23 and an angular contact ball bearing fixing groove 24.

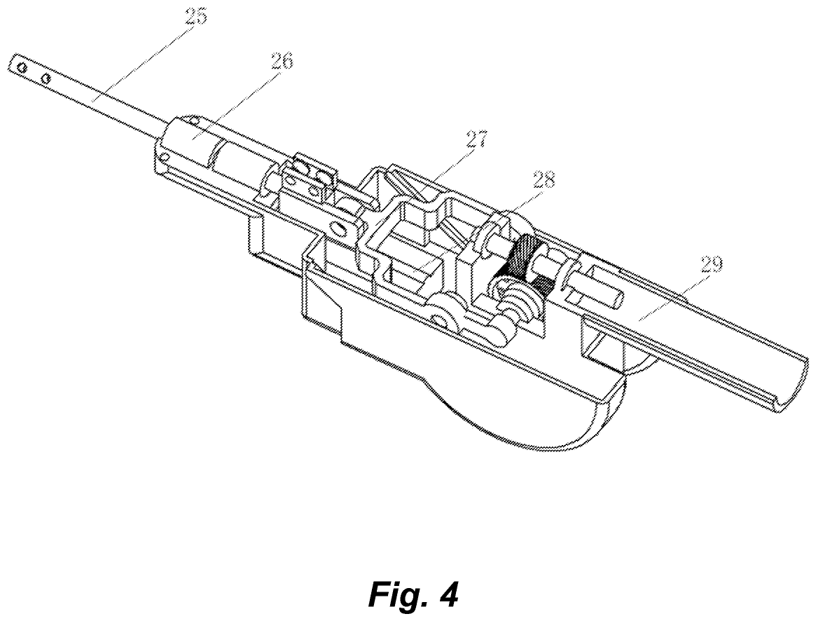

As shown in FIG. 4, in the portable telescopic push-pull vibrating-shaking type Camellia oleifera fruit picking and beating machine, the gear shifting mechanism 2 includes a telescopic rod 25 for connecting and fixing the picking and beating head 1, the telescopic rod 25 penetrates through the linear sliding bearing 26, a worm and worm wheel mechanism 27 is fixedly connected to a tail portion of the telescopic rod 25, and a rear portion of the worm and worm wheel mechanism 27 is provided with a steel tube track 28 and a power transmission and picking and beating rod fixing groove 29.

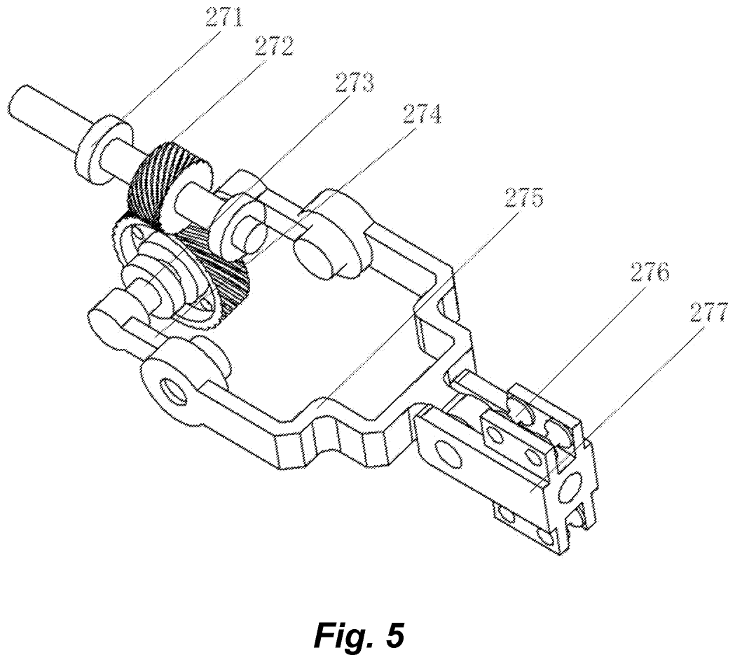

As shown in FIG. 4 and FIG. 5, in the portable telescopic push-pull vibrating-shaking type Camellia oleifera fruit picking and beating machine, the worm and worm wheel mechanism 27 includes a slider 277 fixedly connected to the telescopic rod 25, and the slider 277 is provided with a pulley 276 connected to the steel tube track 28. A rear portion of the slider 277 is provided with a double-crank connecting rod 275, and the slider 277 is indirectly connected to rotating arms 274 through the double-crank connecting rod 275, and is connected to a worm wheel 273 through the rotating arms 274 and the double-crank connecting rod 275. The rotating arms 274 are connected to a worm 272 arranged on the worm wheel 273 through the worm wheel 273, and both sides of each of the worm 272 and the worm wheel 273 on the rotating arm 274 are provided with the angular contact ball bearings 271. The power transmission and picking and beating rod 3 is connected to the worm 272 in the gear shifting mechanism 2 and the DC motor 4 through particular hexagonal keyhole interfaces. A rotation of the DC motor 4 is transmitted to the worm 272 in the gear shifting mechanism 2 through the power transmission rod 31 in the power transmission and picking and beating rod 3, a rotation of the worm 272 drives the worm wheel 273 to rotate, a rotation of the worm wheel 273 drives the symmetrical rotating arms 274 on both sides to make 360° motion, and the other ends of the rotating arms 274 are connected to the slider 277 through the double-crank connecting rod 275 to drive the slider 277 to make back-and-forth push-pull motion. Each of an upper portion and a lower portion of the up-down symmetrical slider 277 is provided with two pulleys 276, and the slider 277 drives the pulleys 276 to move back and forth on the steel tube track 28, and the other end of the slider 277 is connected to the telescopic rod 25 to drive the telescopic rod 25 to extend and retract.

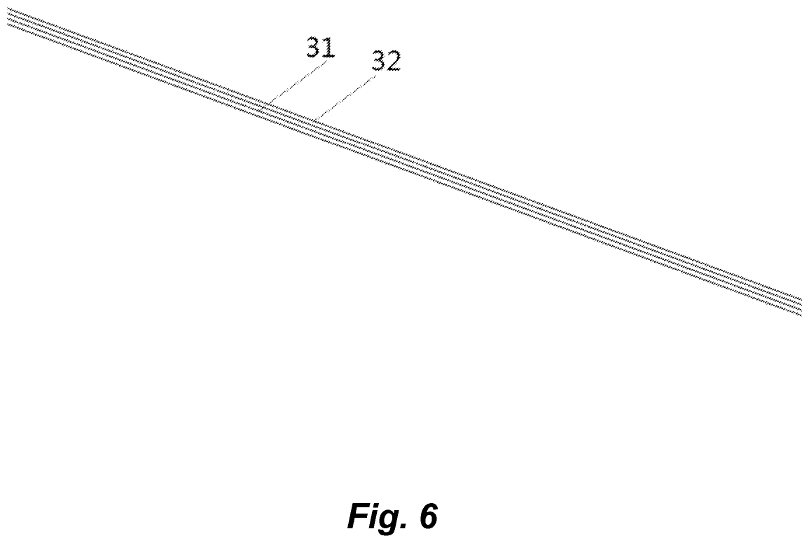

As shown in FIG. 6, the power transmission and picking and beating rod 3 includes a power transmission rod 31. The power transmission rod 31 is externally wrapped with a plastic housing 32, and the power transmission and picking and beating rod 3 is connected to the gear shifting mechanism 2 and the DC motor 4.

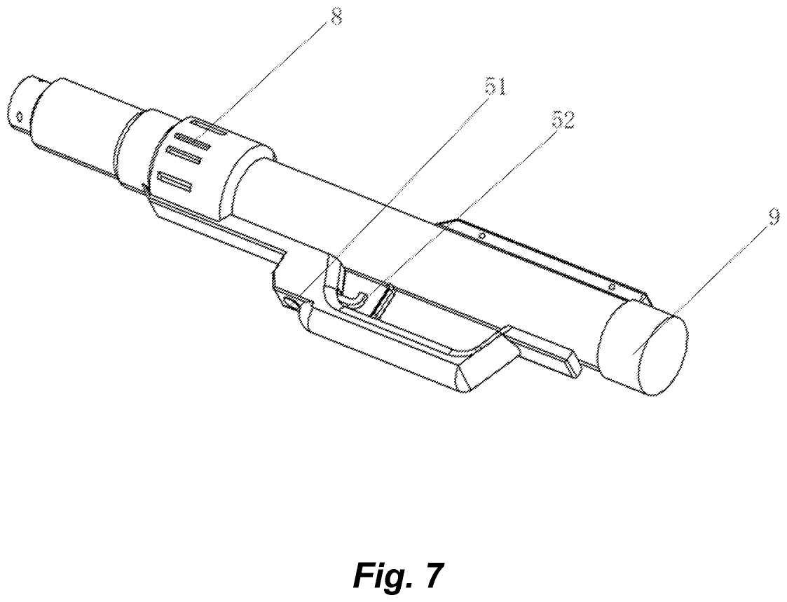

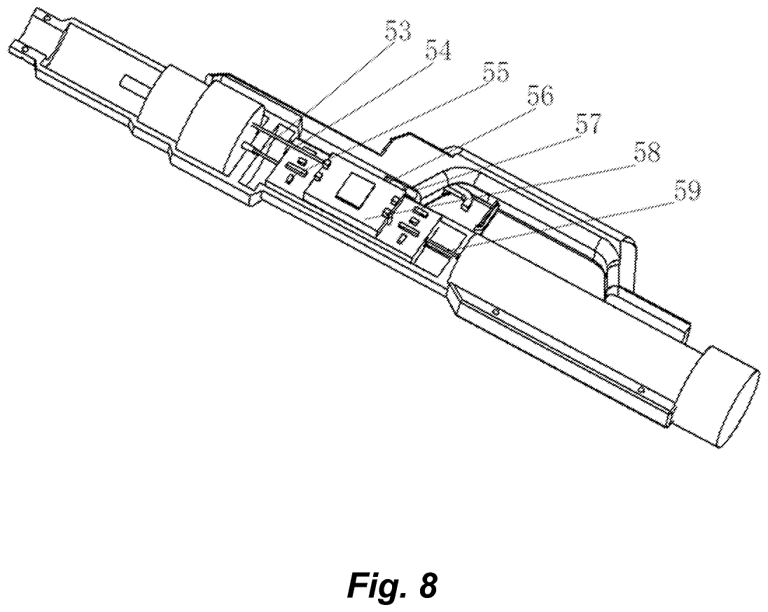

As shown in FIG. 7 and FIG. 8, in the portable telescopic push-pull vibrating-shaking type Camellia oleifera fruit picking and beating machine, a housing surface of the DC motor 4 is provided with DC motor thermal vias 8. The control system 5 includes power switch 51, a start switch 52 is arranged at a side portion of the power switch 51, and the power switch 51 and the start switch 52 are installed on the handheld grip 6. The power switch 51 and the start switch 52 are electrically connected to a circuit board 55 by means of a power switch wire 56 and a start switch wire 57, respectively. The circuit board 55 is electrically connected to the lithium battery 7 by means of a battery wire 59 and is electrically connected to the DC motor 4 by means of a DC motor wire 53. A STM-32 single chip microcomputer 58 is arranged on the circuit board 55, one end of the STM-32 single chip microcomputer 58 is electrically connected to the circuit board 55, and the other end of the STM-32 single chip microcomputer 58 is electrically connected to the DC motor 4 by means of a control wire 54. The DC motor 4 is a single-stage planetary outer-rotor self-cooling brushless motor with the power of 400 W, and rotational speed of the motor is from 6,000 r/min to 12,000. The STM-32 single chip microcomputer 58 is used to control the rotational speed of the DC motor 4 by receiving a signal from the force sensor 13 and reasoning using a fuzzy reasoning rule algorithm, so as to achieve slow start and automatic augmentation of the power, and a current of the DC motor 4 is fed back to the STM-32 single chip microcomputer 58, and a power-off protection is achieved by a fuzzy control of the control system 5. A tail portion of the control system 5 is electrically connected to the lithium battery 7 by means of a battery wire 59, and a tail portion of the lithium battery 7 is provided with a battery back cover 9 connected to the control system 5. The lithium battery 7 is a rechargeable high-performance special lithium battery independently developed, which can operate for 3-4 hours when fully charged.

As shown in FIG. 1, the portable telescopic push-pull vibrating-shaking type Camellia oleifera fruit picking and beating machine includes a picking and beating head 1, a gear shifting mechanism 2, a power transmission and picking and beating rod 3, a DC motor 4, a control system 5, a handheld grip 6, and a lithium battery 7. During operation, it should be ensured first that the lithium battery 7 is in a charged state, the battery back cover 9 is mounted after the lithium battery 7 is assembled. In order to fetch conveniently, the picking and beating machine can be assembled under the Camellia oleifera fruit tree. First, the height of the Camellia oleifera fruit tree should be determined, so as to determine whether the power transmission and picking and beating rod 3 should be lengthened or not. If the power transmission and picking and beating rod needs to be lengthened, a spare power transmission and picking and beating rod 3 can be taken out for connection. Both ends of the power transmission and picking and beating rod 3 are respectively connected to the DC motor 4 and the gear shifting mechanism 2, and the other end of the gear shifting mechanism 2 is connected to the picking and beating head 1, and in this, the assembly is finished. A Camellia oleifera branch needing to be picked is selected, and then the branch is hooked by the long hook on the picking and beating head. After the branch is fixed, the handheld grip 6 is held with one hand, and the power switch 51 and the start switch 52 are turned on with the other hand, where the power switch 51 is turned on first, which is pressed for three seconds to prevent accidental contact, and then the start switch 52 is turned on to start operation. After the switch is pressed, the handheld grip 6 is held with both hands to wait for the DC motor 4 to rotate slowly. The rotation of the DC motor 4 drives the power transmission rod 31 in the power transmission and picking and beating rod 3 to rotate together, one end of the power transmission rod 31 is connected to the worm 272 in the gear shifting mechanism 2, and the rotation of the worm 272 is about to inevitably drive the worm wheel below 273 to rotate together, and in this case, the direction of force has also changed. Symmetric rotating arms 274 are arranged on both sides of the worm wheel 273, and by means of 360° rotational motion, the rotating arms 274 are enabled to make back-and-forth push-pull motion through the slider 277 connected to the double-crank connecting rod 275. The slider is further assembled with the pulleys 276 and the steel tube track 28 to reduce friction and the loss of kinetic energy, thus making the vibration and shaking more powerful. The slider 277 is connected to the telescopic rod 25, and thus the back-and-forth push-pull motion can be transmitted to the telescopic rod, and due to the fac that the other end of the telescopic rod is connected to the picking and beating head 1, the push-pull motion is brought to the picking and beating head 1. As the picking and beating head 1 is fixed to the branch, the Camellia oleifera can be picked by impacting the branch through the push-pull vibrating-shaking motion. After a power supply is turned on, the force sensor 13 and the displacement sensor 14 start to operate. By detecting the picking and beating strength and the thickness of the branches, the received force is converted into an electrical signal to be transmitted to the STM-32 single chip microcomputer 58, which adjusts the rotational speed of the DC motor 4 according to the fuzzy reasoning rule, so as to cope with the branches with different thicknesses and give appropriate picking and beating strength to pick the Camellia oleifera fruits without damaging the branches. When the picking and beating head is stuck on the branch, the DC motor 4 is about to be overloaded. At this time, the STM-32 single chip microcontroller 58 can cut off the power supply to the DC motor 4 immediately to prevent the DC motor 4 from stalling and burning out. At this time, the machine can continue to operate by pressing the switch after taking the picking and beating head 1 off the branch and hanging the picking and beating head 1 on the branch again.

The design of a rotational speed fuzzy controller for the DC motor is introduced in detail below, and a fuzzy decision is achieved through the following steps:

(1) The picking and beating strength and the thickness grade of Camellia oleifera branches detected in a certain period are used as an input of a fuzzy decision control system.

(2) The picking and beating strength and the thickness grade of Camellia oleifera branches detected in Step (1) are fuzzified according to the triangular membership function.

(3) A fuzzy vector obtained in above Step (2) is reasoned according to a fuzzy rule table, so as to obtain a rotational speed fuzzy control output vector of the DC motor 4.

Design of rotational speed fuzzy controller for DC Motor 4:

A triangular membership function method is established according to the thickness grade of the Camellia oleifera branches and the picking and beating strength detected in a certain period as follows:

$$𝒰 branch thickness \{ \begin{matrix}{𝒰}_{A ( x )} & = & ( 10 - x ) / 10 & 0 \leq x \leq 10 \\ {𝒰}_{B ( x )} & = & \{ \begin{matrix}( x - 10 ) / 5 \\ ( 20 - x ) / 5\end{matrix} & \begin{matrix}10 \leq x \leq 15 \\ 15 \leq x \leq 20\end{matrix} \\ {𝒰}_{C ( x )} & = & \{ \begin{matrix}( x - 20 ) / 5 \\ ( 30 - x ) / 5\end{matrix} & \begin{matrix}20 \leq x \leq 25 \\ 25 \leq x \leq 30\end{matrix} \\ {𝒰}_{D ( x )} & = & \{ \begin{matrix}( x - 30 ) / 5 \\ ( 40 - x ) / 5\end{matrix} & \begin{matrix}30 \leq x \leq 35 \\ 35 \leq x \leq 40\end{matrix} \\ {𝒰}_{E ( x )} & = & \{ \begin{matrix}( x - 40 ) / 5 \\ ( 50 - x ) / 5\end{matrix} & \begin{matrix}40 \leq x \leq 45 \\ 45 \leq x \leq 50\end{matrix}\end{matrix}$$

$${𝒰}_{\begin{matrix}picking and \\ beating strength\end{matrix}} \{ \begin{matrix}{𝒰}_{S ( y )} & = & \{ \begin{matrix}( y - 55 ) / 2 \\ ( 59 - y ) / 2\end{matrix} & \begin{matrix}55 \leq y \leq 57 \\ 57 \leq y \leq 59\end{matrix} \\ {𝒰}_{MS ( y )} & = & \{ \begin{matrix}( y - 59 ) / 2 \\ ( 63 - y ) / 2\end{matrix} & \begin{matrix}59 \leq y \leq 61 \\ 61 \leq y \leq 63\end{matrix} \\ {𝒰}_{M ( y )} & = & \{ \begin{matrix}( y - 63 ) / 2 \\ ( 67 - y ) / 2\end{matrix} & \begin{matrix}63 \leq y \leq 65 \\ 65 \leq y \leq 67\end{matrix} \\ {𝒰}_{MB ( y )} & = & \{ \begin{matrix}( y - 67 ) / 2 \\ ( 71 - y ) / 2\end{matrix} & \begin{matrix}67 \leq y \leq 69 \\ 69 \leq y \leq 71\end{matrix} \\ {𝒰}_{B ( y )} & = & \{ \begin{matrix}( y - 71 ) / 2 \\ ( 75 - y ) / 2\end{matrix} & \begin{matrix}71 \leq y \leq 73 \\ 73 \leq y \leq 75\end{matrix}\end{matrix}$$

where μ denotes a triangular membership function; x denotes a diameter of a Camellia oleifera branch; y denotes a force on the branch when the machine vibrates; A-E indicate that the thickness grade of the branches is from low to high (A-thin, B-medium thin, C-medium, D-medium thick, E-thick); S-B indicate that the picking and beating strength is from low to high (S-small, MS-medium small, M-medium, MB-medium big, B-big).

According to the experience of experts and farmers, the diameter of the Camellia oleifera branch is generally from 0 mm to 50 mm, and when the branch is picked and beat in a vibrating-shaking manner, the force exerted by vibration on the branch is about 55-75 N. The thickness of the Camellia oleifera branch and the picking and beating strength are fuzzified using a fuzzy subset of five elements {thin (A), medium thin (B), medium (C), medium thick (D) and thick (E)} having a value range of (0, 50), and a fuzzy subset of five elements {small(S), medium small (MS), medium (M), medium big (MB) and big (B)} having a value range of (55, 75).

According to the experience of experts, the rotational speed of the DC motor 4 should be controlled at 6,000-12,000 r/min when the push-pull vibrating-shaking Camellia oleifera fruit picking and beating machine is used to pick and beat the Camellia oleifera fruit. According to the thickness of the branch and the picking and beating strength, and through empirical judgment, the rotational speed of the DC motor 4 is a fuzzy subset of five elements {low (L), medium low (ML), medium high (M), medium high (MH) and high (H)} having a value range of (6000,12000), which is fuzzified by the triangular membership function.

$${𝒰}_{\begin{matrix}motor rotational \\ speed\end{matrix}} \{ \begin{matrix}{𝒰}_{S ( p )} & = & ( 7200 - p ) / 1200 & 6000 \leq p \leq 7200 \\ {𝒰}_{MS ( p )} & = & \{ \begin{matrix}( p - 7200 ) / 600 \\ ( 8400 - p ) / 600\end{matrix} & \begin{matrix}7200 \leq y \leq 7800 \\ 7800 \leq y \leq 8400\end{matrix} \\ {𝒰}_{M ( p )} & = & \{ \begin{matrix}( p - 8400 ) / 600 \\ ( 9600 - p ) / 600\end{matrix} & \begin{matrix}8400 \leq y \leq 9000 \\ 9000 \leq y \leq 9600\end{matrix} \\ {𝒰}_{MF ( p )} & = & \{ \begin{matrix}( p - 9600 ) / 600 \\ ( 10200 - p ) / 600\end{matrix} & \begin{matrix}9600 \leq y \leq 10200 \\ 10200 \leq y \leq 10800\end{matrix} \\ {𝒰}_{F ( p )} & = & ( 12000 - p ) / 1200 & 10800 \leq p \leq 12000\end{matrix}$$

where μ denotes a triangular membership function; p represents the rotational speed of the motor; S-F indicate that the rotational speed of the motor is from low to high (S-slow, MS-medium slow, M-medium, MF-medium fast, F-fast).

Further, according to the thickness of the branch and the picking and beating strength, the rotational speed rule of the DC motor 4 is established as follows:
a. The smaller the picking and beating strength and the thicker the branch, the faster the rotational speed of the motor.
b. The bigger the picking and beating strength and the thinner the branch, the slower the rotational speed of the motor.
c. When the picking and beating strength is medium and the thickness of the branch is medium, the rotational speed of the motor is medium.

The following fuzzy control rule table of the thickness of branch, the picking and beating strength and rotational speed of the DC motor 4 is obtained as shown in Table 1 below.

Therefore, when the force sensor 13 and the displacement sensor 14 transmit signals to the fuzzy controller, i.e., the STM-32 single chip microcomputer 58, the rotational speed of the motor can be adaptively controlled through the fuzzy control rule.

TABLE
Fuzzy control rule of rotational speed of DC motor in embodiment

| Rotational | | Thickness grade of branch | | | | |
|---|---|---|---|---|---|---|
| speed of motor | | A | B | C | D | E |
| Picking and | S | M | MF | MF | F | F |
| beating strength | MS | M | M | MF | MF | F |
| | M | MS | MS | M | MF | MF |
| | MB | S | MS | MS | M | M |
| | B | S | S | MS | MS | M |

Although the embodiments of the present disclosure have been shown and described, those skilled in the art can understand that many changes, modifications, substitutions and variations can be made to these embodiments without departing from the principles and purposes of the present disclosure, and the scope of the present disclosure is defined by the claims and their equivalents.

What is claimed is:

1. A portable telescopic push-pull vibrating-shaking type Camellia oleifera fruit picking and beating machine, mainly comprising a picking and beating head (1), a gear shifting mechanism (2), a power transmission and picking and beating rod (3), a direct current (DC) motor (4), a control system (5), a handheld grip (6), and a lithium battery (7), wherein the picking and beating rod (1) comprises a long hook (11), the long hook (11) is provided with a silicone case (12) at an inner upper end and a displacement sensor (14) at an inner lower end, and a tail portion of the long hook (11) is provided with a force sensor (13) and a telescopic rod fixing hole (15) for connecting and fixing the gear shifting mechanism (2);
the gear shifting mechanism (2) comprises a telescopic rod (25) for connecting and fixing the picking and beating head (1), the telescopic rod (25) penetrates through a linear sliding bearing (26), and a worm and worm wheel mechanism (27) is fixedly connected to a tail portion of the telescopic rod (25); a rear portion of the worm and worm wheel mechanism (27) is provided with a steel tube track (28) and a power transmission and picking and beating rod fixing groove (29); the power transmission and picking and beating rod (3) comprises a power transmission rod (31), the power transmission rod (31) is externally wrapped with a plastic housing (32), and the power transmission and picking and beating rod (3) is connected to the gear shifting mechanism (2) and the DC motor (4);
a housing surface of the DC motor (4) is provided with DC motor thermal vias (8); the control system (5) comprises a power switch (51), a start switch (52) is arranged at a side portion of the power switch (51), and the power switch (51) and the start switch (52) are installed on the handheld grip (6); the power switch (51) and the start switch (52) are electrically connected to a circuit board (55) by means of a power switch wire (56) and a start switch wire (57), respectively; the circuit board (55) is electrically connected to the lithium battery (7) by means of a battery wire (59) and is electrically connected to the DC motor (4) by means of a DC motor wire (53); a STM-32 single chip microcomputer (58) is arranged on the circuit board (55), one end of the STM-32 single chip microcomputer (58) is electrically connected to the circuit board (55), and the other end of the STM-32 single chip microcomputer (58) is electrically connected to the DC motor (4) by means of a control wire (54).

2. The portable telescopic push-pull vibrating-shaking type Camellia oleifera fruit picking and beating machine according to claim 1, wherein the picking and beating head (1) detects picking and beating strength at any time by the force sensor (13), is able to achieve an adaptive control through a fuzzy control system, and is fixedly connected with the telescopic rod (25) of the gear shifting mechanism (2) through a telescopic rod fixing hole (15).

3. The portable telescopic push-pull vibrating-shaking type Camellia oleifera fruit picking and beating machine according to claim 1, wherein the gear shifting mechanism (2) further comprises a linear sliding bearing fixing groove (21) for fixedly mounting the linear sliding bearing (26), a rear portion of the linear sliding bearing fixing groove (21) is provided with a steel tube track (22), and a rear portion of the steel tube track (22) is provided with a rotating rod fixing groove (23) and an angular contact ball bearing fixing groove (24).

4. The portable telescopic push-pull vibrating-shaking type Camellia oleifera fruit picking and beating machine according to claim 1, wherein the worm and worm wheel mechanism (2) comprises a slider (277) fixedly connected to the telescopic rod (25), the slider (277) is provided with a pulley (276) connected to a steel tube track (28), a rear portion of the slider (277) is provided with a double-crank connecting rod (275), and the slider (277) is indirectly connected to rotating arms (274) through the double-crank connecting rod (275), and is connected to a worm wheel (273) through the rotating arms (274) and the double-crank connecting rod (275);
the rotating arms (274) are connected to a worm (272) arranged on the worm wheel (273) through the worm wheel (273), and both sides of each of the worm (272) and the worm wheel (273) on the rotating arm (274) are provided with the angular contact ball bearings (271).

5. The portable telescopic push-pull vibrating-shaking type Camellia oleifera fruit picking and beating machine according to claim 4, wherein the power transmission and picking and beating rod (3) is connected to the worm (272) in the gear shifting mechanism (2) and the DC motor (4) through particular hexagonal keyhole interfaces.

6. The portable telescopic push-pull vibrating-shaking type Camellia oleifera fruit picking and beating machine according to claim 5, wherein a rotation of the DC motor (4) is transmitted to the worm (272) in the gear shifting mechanism (2) through the power transmission rod (31) in the power transmission and picking and beating rod (3), a rotation of the worm (272) drives the worm wheel (273) to rotate, and a rotation of the worm wheel (273) drives the symmetrical rotating arms (274) on both sides to make 360° motion, the other ends of the rotating arms (274) are connected to the slider (277) through the double-crank connecting rod (275) to drive the slider (277) to make back-and-forth push-pull motion, and each of an upper portion and a lower portion of the up-down symmetrical slider (277) is provided with two pulleys (276), and the slider (277) drives the pulleys (276) to move back and forth on the steel tube track (28), and the other end of the slider (277) is connected to the telescopic rod (25) to drive the telescopic rod (25) to extend and retract.

7. The portable telescopic push-pull vibrating-shaking type Camellia oleifera fruit picking and beating machine according to claim 1, wherein the DC motor (4) is a single-stage planetary outer-rotor self-cooling brushless motor with the power of 400 W, and rotational speed of the motor is from 6,000 r/min to 12,000.

8. The portable telescopic push-pull vibrating-shaking type Camellia oleifera fruit picking and beating machine according to claim 1, wherein the STM-32 single chip microcomputer (58) is used to control the rotational speed of the DC motor (4) by receiving a signal from the force sensor (13) and reasoning using a fuzzy reasoning rule algorithm, so as to achieve slow start and automatic augmentation of the power, and a current of the DC motor (4) is fed back to the STM-32 single chip microcomputer (58), and a power-off protection is achieved by a fuzzy control of the control system (5).

9. The portable telescopic push-pull vibrating-shaking type Camellia oleifera fruit picking and beating machine according to claim 1, wherein a tail portion of the control system (5) is electrically connected to the lithium battery (7) by means of a battery wire (59), and a tail portion of the lithium battery (7) is provided with a battery back cover (9) connected to the control system (5).

10. The portable telescopic push-pull vibrating-shaking type Camellia oleifera fruit picking and beating machine according to claim 9, wherein the lithium battery (7) is a rechargeable high-performance special lithium battery independently developed, which is able to operate for 3-4 hours when fully charged.
